(19) United States
(12) Patent Application Publication
(10) Pub. No.: US 2024/0121461 A1
(43) Pub. Date: Apr. 11, 2024

(54) Integrated Video Production System and Method for Video Production

(71) Applicant: EVS Broadcast Equipment SA, Seraing (BE)

(72) Inventors: Oliver Barnich, Liège (BE); Mathieu Delvaux, Wanze (BE); Jean-François Degbomont, Stavelot (BE)

(21) Appl. No.: 18/462,520

(22) Filed: Sep. 7, 2023

(30) Foreign Application Priority Data
Sep. 9, 2022 (EP) 22194739.3

(51) Int. Cl. H04N 21/274; H04N 5/268; H04N 5/77; H04N 19/40; H04N 21/472

(52) U.S. Cl. CPC H04N 21/274; H04N 5/268; H04N 5/77; H04N 19/40; H04N 21/47217

(57) ABSTRACT

A video production system comprising a plurality of low usage cameras (104), a plurality of high usage cameras (103) and a video production server (201) which ingests and stores camera streams provided by the plurality of high usage cameras (103). The system further comprises a cloud recorder (207). The cloud recorder (207) ingests and stores camera streams provided by the plurality of low usage cameras (104). The cloud recorder (207) is communicatively connected via a first data connection (212) with a replay device (211) enabling an operator to browse through all the recorded camera streams from the plurality of low usage cameras (104) and to select one the recorded camera streams for replay by sending a corresponding command to the cloud recorder (207). The cloud recorder is communicatively connected via a second data connection (216) for providing the recorded camera stream that has been selected to the video production server (201).

### FIELD

The present disclosure relates to an integrated video production system and a method for video production.

### BACKGROUND

In broadcast productions covering an event, e.g. a sports event, multiple cameras capture the event from different perspectives. To this end, there are cameras which are installed at positions where most of the action in the event is expected. Consequently, the camera streams provided by these cameras are frequently used in the program output stream of the video production. Therefore, these cameras are labeled “high usage cameras” in the present application. In addition to the high usage cameras, there are other cameras capturing images from a specific perspective that may be interesting or not depending on how the event evolves. An example of such other cameras is a camera mounted in the cockpit of a racing car capturing the perspective of the racing car driver. It may therefore happen that the camera stream from such camera is not used at all in the production. However, if for instance an accident happens just in front of the racing car capturing the scene, the camera stream from such camera is very interesting and will be used in the production. Consequently, these cameras are labeled “low usage cameras” in the present application to distinguish them from the high usage cameras. Since it is unpredictable whether the camera stream of a low usage camera will be important for the production or not it is necessary to record all camera streams of the low usage cameras to enable a replay of the scene which is a valuable contribution to the video production.

The camera streams of the high usage cameras are typically recorded on a video production server providing integrated video recording capabilities. However, the video production server is a very expensive device and has a limited video recording capacity which in most cases does not allow for recording all camera streams from low usage cameras. Rather, the recording capacity is limited to recording the camera streams from the high usage cameras.

Taking this as a starting point there is a need for a video production system and a method enabling cost-efficient recording of camera streams from a plurality of high usage and low usage cameras.

### SUMMARY

According to a first aspect the present disclosure suggests a video production system comprising a plurality of low usage cameras, a plurality of high usage cameras, and a video production server, which ingests and stores camera streams provided by the plurality of high usage cameras. The system further comprises a cloud recorder. The cloud recorder ingests and stores camera streams provided by the plurality of low usage camera. The cloud recorder is communicatively connected via a first data connection with a replay device enabling an operator to browse through all the recorded camera streams from the plurality of low usage cameras and to select one of the recorded camera streams for replay by sending a corresponding command to the cloud recorder. Furthermore, the cloud recorder is communicatively connected via a second data connection for providing the recorded camera stream that has been selected to the video production server.

The cloud recorder can be rented on an as needed basis in terms of duration and capacity depending on the covered event. This approach is more cost efficient than providing additional video production servers for storing the camera streams of the low usage cameras on site or in a studio because video production servers are expensive devices.

The terms “cloud” and “cloud recorder” are to be understood in a broad sense. The term “cloud” may refer to a public cloud service and/or to infrastructure located in a remote data center that is, for example, reserved for the broadcaster and not accessible to the public.

In an advantageous embodiment the cloud recorder is adapted for transferring the recorded camera streams as low bit rate data streams via the first data connection and for transferring the selected camera stream as a high bit rate data stream via the second data connection.

The low bit rate data stream has a bit rate of 1 to 10 MB per second per camera stream while the high bit rate camera stream ranges from 50 to 800 MB per second per camera stream. However, the proposed bit rates are only an example, and the present disclosure is not limited to a specific bit rate or range of bit rates.

It has been found useful to provide for a video encoder for encoding the camera streams of the low usage cameras. An appropriately encoded camera stream can reduce the required bandwidth of data connection for transferring the camera streams.

In a further advantageous embodiment, the second data connection connects the cloud recorder with a file access and transcoder device receiving a command from the replay device identifying the selected camera stream. The file access and transcoder device downloads the selected camera stream from the cloud recorder.

In this case it has been found useful when the file access and transcoder device transcodes the downloaded camera stream and transfers it to the video production server.

Transcoding the downloaded file facilitates the integration of the selected camera stream into the video production because the camera streams from the high usage cameras may have a different format.

According to a second aspect the present disclosure suggests a method for video production. The method comprises
storing camera streams on a cloud recorder,
providing all recorded camera streams as low data rate streams enabling an operator to browse through all recorded camera streams
selecting one recorded camera stream for replay; and
providing the selected camera stream as a high data rate stream to a video production server.

According to a preferred embodiment of the method, the step of selecting a camera stream also involves defining a beginning and ending of the camera stream. Thus, only the portion of the camera stream between the defined beginning and the ending of the video clip is transferred from the cloud recorder to the video production server. This approach limits the data traffic to a necessary minimum.

### BRIEF DESCRIPTION OF THE DRAWINGS

Exemplary embodiments of the present disclosure are illustrated in the drawings and are explained in more detail in the following description. In the figures, the same or similar elements are referenced with the same or similar reference signs. It shows:

FIG. 1 is a schematic illustration of a sports event which is covered by high usage and low usage cameras;

FIG. 2 is a schematic illustration of an architecture of an integrated video production system according to the present disclosure; and

FIG. 3 is a flow diagram of a video production method according to the present disclosure.

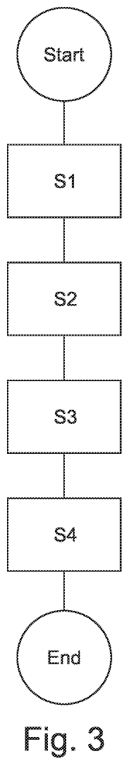

In the figures the same or similar components are labelled with the same or similar reference signs.

### DETAILED DESCRIPTION

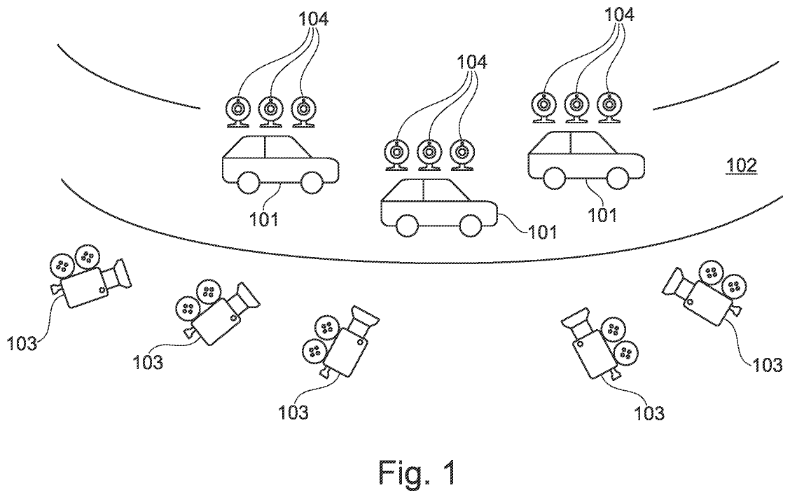

FIG. 1 schematically displays a sports event and more particularly a racing event. FIG. 1 displays three racing cars 101 racing on a racing track 102. Cameras 103 are installed along the racing track at the most interesting locations of the racing track 102 such as curves, chicanes or the home stretch. The camera streams of the cameras 103 are included most of the time in a program output stream of the video production. Therefore, the cameras 103 are labeled as high usage cameras. In addition to that, there are cameras 104, which are mounted in the racing cars 101 covering different perspectives from the racing car, for instance the view of the racing car driver. Typically, the camera streams of the cameras 104 mounted on board of racing cars 101 are used in the video production only if the camera 104 captures a scene which provides added value to the video production. In other words: Most of the time the camera streams of the cameras 104 are not included in a program output stream. Thus, the cameras 104 are labeled in the present application as “low usage cameras”.

It is noted that the important difference between high usage cameras 103 in the low usage cameras 104 is not whether the cameras are mobile or stationary or their image resolution but rather the fact to which extent their camera streams are used in the program output stream of the video production.

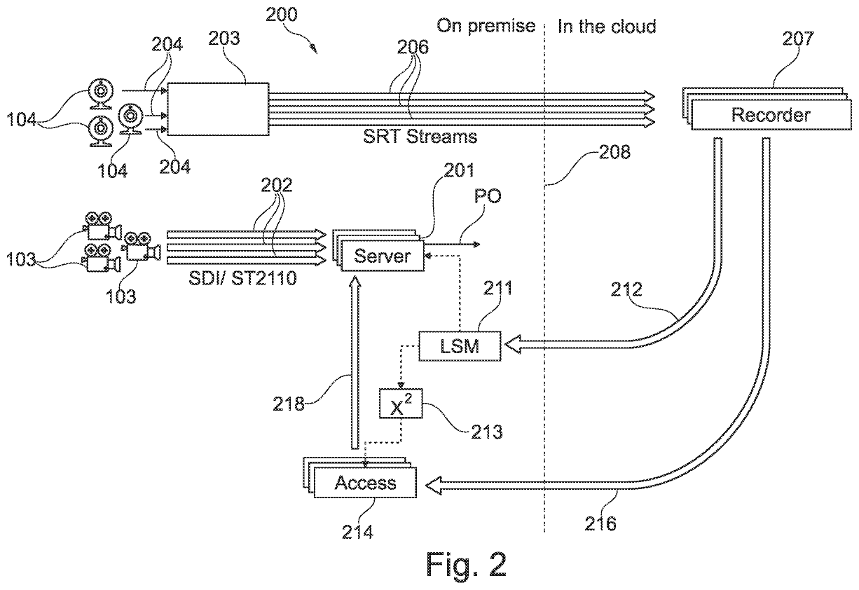

FIG. 2 illustrates an embodiment of a video production system 200 according to the present disclosure. The heart of the video production system 200 is a video production server 201 which receives the camera streams of the high usage cameras 103 via wired and/or wireless data connections 202, e.g. according to the SDI or ST 2110 standard. Such video production server is commercially available for instance from EVS Broadcast Equipment®. The video production server 201 ingests and stores the camera streams from the high usage cameras 103. Furthermore, the video production server 201 provides for mixing functionalities to integrate different camera streams and/or video clips to generate a program output stream PO. For big events with many cameras 103 multiple video production servers 201 can share the tasks to make the video production. For the sake of simplicity, it is assumed in the following that there is only one video production server 201.

The low usage cameras 104 are connected with an encoder 203 via wired and/or wireless data connections 204. The encoder 203 outputs the camera streams of the low usage cameras 104 as encoded data streams. The term “encoded” is to be understood in a broad sense and encompasses e.g., compressed data streams. The camera streams are encoded for example as SRT (secure reliable transport) streams. However, any other suitable transport standard can be used as well. The encoded data streams are transferred via data connections 206 to a cloud recorder 207 that ingests and stores the encoded camera streams. In FIG. 2 a vertical dashed line 208 separates devices on site of the video production and in the cloud. Devices on the left side of the dashed line 208 are on site while the cloud recorder 207 on the right-hand side of the dashed line 208 is implemented in the cloud.

A replay device 211 is connected to the cloud recorder 207 by a data connection 212. In this way the replay device 211 has access to all stored camera streams from the cameras 104. The camera streams are provided as low data rate streams in the range of 1 to 10 MB per second per camera stream by the cloud recorder. In this way the replay device 211 enables an operator to browse through camera streams recorded on the cloud recorder 207. When the operator finds a recorded video clip, the operator defines an entry and exit point for the clip and sends this as a command to a media workflow management device 213 that essentially is a single-entry point to orchestrate and monitor media files as they move through the live production. The media workflow management device 213 sends a command to an access and transcoder device 214 that receives the selected video clip via a data connection 216 as a high data rate data stream in the range of 50 to 800 MB per second. The access and transcoder device 214 transcodes the selected video clip to facilitate its integration into the program output stream by the video production server 201. To this end the access and transcoder device 214 is connected by a data connection 218 with the video production server 201.

In an alternative embodiment the selected camera stream is transferred entirely to the video production server 201. The editing of the camera stream is then performed on the video production server, i.e., the entry and the exit (beginning and ending) of the video clip is defined on the selected camera stream stored on the video production server.

One important advantage of the architecture of the video production system 200 according to the present disclosure is the scalability of the cloud recorder 207. The cloud recorder can be rented on an as needed basis in terms of duration and capacity. I.e. if many camera streams from low usage cameras 104 need to be recorded, the cloud recorder 207 can be scaled accordingly. Therefore, the broadcaster does not the need to provide for a lot of hardware that can handle storage and processing capabilities for big events when such events only occur from time to time. This is an important cost advantage for the broadcaster.

The video production system 200 enables an adapted method for video production. The method comprises a first step S1 storing of camera streams on the cloud recorder 207. In step S2 all recorded camera streams are provided as low data rate streams enabling an operator to browse through all recorded camera streams. In step S3 the operator selects one recorded camera stream for replay. Finally, the selected camera stream is provided as a high data rate stream to a video production server.

1. A video production system comprising a plurality of low usage cameras, a plurality of high usage cameras and a video production server which ingests and stores camera streams provided by the plurality of high usage cameras, wherein the system further comprises a cloud recorder,
wherein the cloud recorder ingests and stores camera streams provided by the plurality of low usage cameras;
wherein the cloud recorder is communicatively connected via a first data connection with a replay device enabling an operator to browse through all the recorded camera streams from the plurality of low usage cameras and to select one of the recorded camera streams for replay by sending a corresponding command to the cloud recorder; and
wherein the cloud recorder is communicatively connected via a second data connection for providing the recorded camera stream that has been selected to the video production server.

2. The video production system according to claim 1, wherein the cloud recorder is adapted for transferring the recorded camera streams as low bit rate data streams via the first data connection and for transferring the selected camera stream as a high bit rate data stream via the second data connection.

3. The video production system according to claim 1, further comprising a video encoder for encoding the camera streams of the low usage cameras.

4. The video production system according to claim 1, wherein the second data connection connects the cloud recorder with a file access and transcoder device receiving a command from the replay device identifying the selected camera stream, wherein the file access and transcoder device downloads the selected camera stream from the cloud recorder.

5. The video production system according to claim 4, wherein the file access and transcoder device transcodes the downloaded camera stream and transfers it to the video production server.

6. A method for video production system comprising
storing camera streams on a cloud recorder;
providing all recorded camera streams as low data rate streams enabling an operator to browse through all recorded camera streams;
selecting one recorded camera stream for replay; and
providing the selected camera stream as a high data rate stream to a video production server.

7. The method according to claim 6, wherein selecting a camera stream also involves defining a beginning and ending of the camera stream.
